(19) United States
(12) Patent Application Publication
(10) Pub. No.: US 2010/0101828 A1
(43) Pub. Date: Apr. 29, 2010

(54) MAGNET WIRE WITH COATING ADDED WITH FULLERENE-TYPE NANOSTRUCTURES

(75) Inventors: Edgar Alberto Duarte Pena, Monterrey (MX); Maria Guadalupe Rodriguez Garcia, Monterrey (MX)

Correspondence Address: MICHAEL WINFIELD GOLTRY, 4000 N. CENTRAL AVENUE, SUITE 1220, PHOENIX, AZ, 85012, US

(73) Assignee: MAGNEKON, S. A. DE C. V., San Nicolas de los Garza (MX)

(21) Appl. No.: 12/606,827

(22) Filed: Oct. 27, 2009

(30) Foreign Application Priority Data
Oct. 28, 2008 (MX) MX/A/2008/013821

(51) Int. Cl. H01B 7/00; B05D 5/12; C08L 67/00; C08L 77/00; C08L 83/04; C08L 31/00; C08L 75/00; C08K 3/04; C08K 5/13; C08K 5/3415; C08K 5/20; C08K 5/41; C08K 3/22; H01B 3/30

(52) U.S. Cl. 174/120 C; 427/58; 524/601; 524/606; 524/588; 524/570; 524/556; 524/589; 524/496; 524/352; 524/104; 524/233; 524/173; 524/435; 174/110 SR; 977/734

(57) ABSTRACT

A magnet wire consists of an electrical conductor and a coating around the electric conductor, the coating is resistant to corona and/or of a low coefficient of friction, and is composed of 82% to 99.95% by weight of polymeric resin, and 0.05% to 18% by weight of fullerene-type nanostructures.

### TECHNICAL FIELD OF THE INVENTION

This invention relates to electrical conductors covered with wire enamel compositions, and particularly to a corona-resistant coated magnet wire and/or with a low coefficient of friction that contains at least one thermoplastic or thermosetting polymeric resin added with fullerene-type nanostructures homogeneously dispersed.

### BACKGROUND OF THE INVENTION

Covered electrical conductors usually contain layers of electric insulation, also known as enamel compositions or coating compositions formed around a conductor core. The magnet wire is a form of covered electrical conductor, in which the conductive core is a copper wire and the insulation layer or layers contain dielectric materials such as polymer resins, placed peripherally around the copper wire. Magnet wire is used in electromagnetic windings of transformers, electric motors and the like. For use in such windings, the magnet wire insulation must be sufficiently flexible, so that the insulation does not cracked or is not damaged otherwise during winding operations. The insulation system must be sufficiently resistant to abrasion, so that the outer surface of the system can resist friction, scrapings and abrading forces that may be encountered during winding operations. The insulation system must also be sufficiently durable and resistant to degradation so that the insulation properties remain for a long time.

The layer or layers of insulation of coated conductors may fail as a result of the destructive forces of the corona discharge. The corona discharge is a phenomenon especially evident in high-voltage environments (AC or DC), such as in the electromagnetic windings of transformers, electric motors, and similar devices. The corona discharge occurs when conductors and dielectric materials in the presence of a gas (usually air), are submitted to voltages above the corona starting voltage. The corona discharge ionizes the oxygen in the gas to form ozone. The resulting ozone tends to attack the polymeric materials used to form the conductor insulation layers, resulting effectively in a degradation of the polymer and destroying the insulating properties of said insulation on the part of the attack. Based on this, the electrical conductors coated with polymer insulation layers are protected as required against the destructive effects of corona discharge.

Examples of current practices to provide improved insulation systems with corona resistant properties can be found in the following patent documents:

James J. McKeown, in the U.S. Pat. No. 3,577,346, describes electric insulated conductors that have an improved corona resistance comprising a metallic conductor covered by a larger portion of a dielectric polymer intermixed with a smaller amount of an organic-metallic compound, selected from silicon, germanium, tin, lead, phosphorus, arsenic, antimony, bismuth, iron, ruthenium and nickel, and a method for the preparation of the insulated electrical conductors.

John J. Keane and Denis R. Pauze, in the U.S. Pat. No. 4,537,804, describes a corona-resistant enamel wire composition, which comprises a polyimide resin, polyamide, polyester, polyamideimide, polyesterimide or polyetherimide and from about 1% to about 35% by weight of alumina particles dispersed in a finite size less than about 0.1 microns of an inch, where the alumina particles are dispersed in the composition by a high shearing mixing. It also describes a method of providing insulation of one and two corona-resistant layers for an electrical conductor, using the aforementioned compositions and an electrical conductor insulated with a coating of one or two layers with the compositions mentioned above.

Don R. Johnston and Mark Markovitz, in the U.S. Pat. No. 4,760,296, describe resin compositions used as electrical insulation with a unique resistance to corona increased from 10 to 100 times or more by the addition of organo-aluminate, organo-silicon or fine alumina or fine silicon of a critical particle size, and dynamo electric machines and transformers incorporating coils made of strands of wire coated with these novel compositions that have substantially increased consequently their service period.

John E. Hake and David A. Metzler, in the U.S. Pat. No. 5,917,155, describes an electrical conductor coated with a multi-layer insulation, corona-resistant that includes first, second and third layers of insulation. The first layer of insulation is arranged peripherally around the electrical conductor, the second layer peripherally around the first layer, and the third layer is peripherally around the second layer. The second layer is inserted between the first and third layers and comprises 10 parts to 50 parts by weight of alumina particles dispersed in 100 parts by weight of a polymeric binder.

Moreover, at present the magnet wires are produced at very high speeds, and the same applies to the manufacture of windings where a high speed is required for the winding of the magnet wire, therefore the magnet wire is submitted to a great mechanical stress caused by friction, which can damage the insulating coating and even result in an irregular winding.

Examples of current practices that provide solutions to this problem of friction in magnet wires, can be found in the following patent documents:

Jerome A. Preston, in the U.S. Pat. No. 3,632,440, describes a coating composition for magnet wire insulation that consists of high-temperature reaction of a resin of polytrimellitamide-imide with about 0.01% to 25% by weight of two dimensional linear organo polysiloxane.

Charles W. McGregor and Melody L. Sutto, in the U.S. Pat. No. 4,693,936, describe a magnet wire covered with a coating of a low-coefficient friction, composed of a mixture of anhydride acid, a diisocyanate, and polyfunctional organosiloxane.

Harold Robert Otis, et al., in the publication of the English patent application GB-2073479, describe a magnet wire with an insulation coating and an outer coating with a low coefficient of friction composed of a polyamide, preferably nylon 11 and nylon 12.

Virginie Studer, et al., in the U.S. Pat. No. 7,001,970 B2, describe an insulating coating with a low coefficient of friction for a magnet wire composed of polyurethane, polyamidaimide, polyester, polyester-imide, polyester amidaimide, polyimides, polyepoxy compounds and compounds of polyphenyl oxide.

Because of the problems stated above, there is a continual need for insulation coatings of magnet wires that are corona-resistant and/or have a low coefficient of friction, that are easily manufactured for use as electrical insulation. Therefore, the main objective of this invention is to provide a corona-resistant coating and/or with a low friction coefficient, that are useful in various forms of electrical insulation to meet these needs that have been present for a long time.

### SUMMARY OF THE INVENTION

Considering the former and with the purpose of solving the encountered restrictions, the objective of the present invention is to provide a magnet wire consisting of an electric conductor and a coating around the electric conductor, the coating is resistant to corona and/or has a low friction coefficient and consists of 82% to 99.95% by weight of polymer resin; and of 0.05% to 18% by weight of fullerene-type nanostructures.

It is also an objective of the invention to provide a coating composition resistant to corona and/or with a low friction coefficient that comprises from 82% to 99.95% by weight of polymer resin; and from 0.05% to 18% by weight of fullerene-type nanostructures.

Another object of the invention is to provide a method for coating an electrical conductor, the method includes the coating the electrical conductor with a coating composition comprising from 82% to 99.95% by weight of polymeric resin, and from 0.05% to 18% by weight of fullerene type nanostructures.

Finally, the objective of the invention is to provide an electrical winding comprising a coiled magnet wire including an electrical conductor and a coating composed of 82% to 99.95% by weight of polymeric resin; and of 0.05% to 18% by weight of fullerene-type nanostructures.

### BRIEF DESCRIPTION OF THE FIGURES

The characteristic details of the invention are described in the following paragraphs together with the attached drawings, with the purpose of defining the invention, but without limiting its range.

FIG. 1 shows a sectional view of a first embodiment of a magnet wire according to the invention.

FIG. 2 shows a sectional view of a second embodiment of a magnet wire according to the invention.

FIG. 3 shows a sectional view of a third embodiment of a magnet wire according to the invention.

### DETAILED DESCRIPTION OF THE INVENTION

The following description is only intended to represent the way of how the principles of the invention can be implemented in various embodiments. The embodiments described herein do not intend to be a comprehensive representation of the invention. The following embodiments are not to limit the invention to the precise form published in the following detailed description.

The composition of the coating for magnet wire according to this invention shows compounds that in turn may consist of multiple components.

The compounds are described separately hereafter, without necessarily being described in their order of importance.

### Polymeric Resin

The coating composition for magnet wire of this invention contains one or more thermoplastic or thermoset polymer resins among which are acrylics, alkyds of terephthalic acid, polyesters, polyesteramides, polyesteramides, polyesteramidaimides, polyesterurethanes, polyurethanes, epoxy resins, polyvinylformals, polyamides, polyimides, polyamidaimides, polysulfones, polyvinylbutiral, silicon resins, polymers incorporating polyhydantoin, phenol resins, vinyl copolymers, polyolefins, polycarbonates, polyethers, polyetherimides, polyetheramides, polyetheramideimides, polyisocyanates, polyesteramideimides, polyamide-esters, polyimida-esters, and combinations thereof and the like. An example of a commercial product that contains a combination of such polymeric resins is available from Elantas PDG under the commercial name “TERESTER 966”.

### Fullerene-Type Nanostructures

The fulerenes or fullerenes are the third most stable form of carbon after diamond and graphite, and they are presented in the form of spheres, ellipsoids or cylinders. Spherical fullerenes are often called the buckyspheres and the cylinders buckytubes or nanotubes.

The best known fullerene is the buckminsterfullerene. It is the smallest fullerene of C₆₀ in which none of its component pentagons share an edge, if the pentagons have an edge in common, the structure will be destabilized. The structure of C₆₀ is a truncated geometric figure resembling a soccer ball (geodesic dome), consisting of 20 hexagons and 12 pentagons, with a carbon atom at each of the corners of the hexagons and a link along each edge.

The C₂₀ fullerene has no hexagons, only 12 pentagons, while the C₇₀ has 12 pentagons like the buckminsterfullerene, but it has more hexagons, and in this case its shape resembles a rugby ball. A nanotube is an integrated substance composed of polymerized fullerenes in which carbon atoms from a given point link with the carbon atoms of another fullerene. The cylindrical fullerenes can form more complex structures, associating with each other and forming nanotubes.

Fullerenes are not highly reactive due to the stability of graphite-type bonds, and they are also very little soluble in most solvents. The common solvents for fullerenes include toluene and carbon disulphide. Solutions of pure buckminsterfullerene have a deep purple color. The fullerene is the only allotropic form of carbon that can be dissolved. Buckminsterfullerene is not “superaromaticity”, that is, the electrons in hexagonal rings cannot delocate the entire molecule.

A common method to produce fullerenes is passing a strong electric current between two proximate graphite electrodes in an inert atmosphere. The resulting arc between the two electrodes produces a soot deposit that can isolate many different fullerenes.

Carbon nanotubes are an allotropic form of carbon. Their structure can be considered emanating from a graphite sheet rolled on itself. Depending on the degree of winding, and how the original sheet is formed, the result can produce nanotubes with different diameters and inner geometry. These tubes are shaped as if the ends of a sheet were united by their ends to form a joint called single-walled nanotubes or a wall. There are also nanotubes whose structure resembles that of a series of concentric tubes, including some inside others, like matrioska dolls and, of course, increasing thicknesses from the center to the periphery. The latter are multilayered nanotubes or multi-walled nanotubes. Derivatives are known where the tube is closed by a half fullerene sphere, and others that are not closed.

The nanotubes are characterized by electrical properties, if we consider the quantum rules that govern the electrical conductivity with the size and geometry of these nanotubes. These structures can behave, from an electrical point of view in a wide range of behavior. Starting from semiconductor behavior until to present, in some cases, superconductivity. This wide range of conductivities is determined primarily by geometric relations, that is, according to their diameter, twist (chirality) and the number of layers their composition. For example, there are straight nanotubes (armchair and zigzag), in which hexagonal arrangements in the extreme parts of the tube are always parallel to the axis. This distribution, based on the diameter, allows two-thirds of non-chiral nanotubes to be conductors and the rest semiconductors. In the case of chiral nanotubes, the hexagons have a certain angle with respect to the tube axis, that is, the distribution of the lateral hexagons that form the structure present with respect to the central axis of the tube, a helical winding character. This type of conformation hinders the flow of electrons to the states, or strips of conduction, so that approximately only one third of the nanotubes has a significant conduction and always depending on the twist angle.

It should be noted that superconducting nanotubes can act as “quantum conductors”, that is, if the voltage is presented, or voltage difference versus the current intensity does not result in a straight line, but a stepped one. As to the capacity to transport current, it is known they can reach quantities of approximately one billion A/cm², while the conventional copper wires are fused to reach current densities of around one million A/cm². It is also to be noted that all these properties do not depend on the length of the tube, unlike what happens in common cables.

As to their mechanical properties, stability and robustness of the nanotubes links between carbon atoms, provide them with the ability to be one of the most resistant fibers that can be produced today. On the other hand, faced with intense deformation forces are able to deform significantly and maintain an elastic regime. Young's module of nanotubes can vary between 1.3 and 1.8 terapascals. Moreover, these mechanical properties could be improved by combining multiple nanotubes into bundles or ropes. Thus, although a nanotube would break, as they behave as independent units, said fracture would not spread to the adjacent ones. In other words, the nanotubes can act as extremely strong springs against small forces, and faced with bigger loads, they may deform dramatically and return later to their original shape.

The thermal conductivity of nanotubes can be as high as 6000 W/mK at room temperature (taking into account, comparing with another allotropic shape of carbon, that a nearly pure diamond transmits 3320 W/mK). In addition, they are extremely thermally stable, being stable even at 2800° C. in vacuum and 750° C. in air. The properties of nanotubes can be modified by encapsulating metals inside, including gases.

The fullerene-type nanostructures are selected among C₆₀, C₇₀, C₇₆, C₇₈, C₈₄, C₉₆, C₁₀₈, C₁₂₀, single-walled carbon nanotubes, double-walled carbon nanotubes, multi-walled carbon nanotubes, boron-carbon nanotubes, tungsten-carbon nanotubes, tungsten disulfide nanotubes, titanium dioxide nanotubes, carbon fullerenes with a surface treatment, metal fullerene, tungsten disulfide fullerene, molybdenum disulfide fullerene, nanotubes with a surface treatment, and combinations thereof.

In a particular embodiment, the fullerene-type nanostructures is a multi-walled nanotube or a tungsten disulfide at concentrations of about 0.05% to about 18% by weight per weight of the corona-resistant coating composition.

### Solvent

The polymeric resin and fullerene-type nanostructures are mixed with at least one common solvent selected from cresylic acid, N-methylpyrrolidone, phenol, aromatic hydrocarbons (for example, aromine 100, aromine 150 aromine 200), dimethylformamide, mesitol, benzyl alcohol, paracresol, metacresol, m-cresol, toluene, xylene, tetrahydrofuran, dimethyl sulfoxide, butyl alcohol, butyl cellsolve, and combinations thereof.

### Other Compounds

In another alternative embodiment, a slip promoting agent can be incorporated in the coating to improve the sliding properties of the magnet wire. The slide-promoting agent may be a fluorinated organic resin, such as polyvinyl fluoride, tetrafluoroethylene-perfluoro(alky vinyl ethylene) copolymer, tetrafluoroethylene-hexafluoropropylene-perfluoro(alkyl vinyl ether) copolymer, tetrafluoroethylene-perfluoro(alkyl vinyl ether) copolymer, ethylene-tetrafluoroethylene copolymer, polytetrafluoroethylene, polyvinylidene fluoride, ethylene-chlorotrifluoroethylene copolymer, polychlorotrifluoroethylene, carnauba, montan wax, and combinations thereof. Alternatively, the slide-promoting agent can be a carnauba wax, montan wax, and combinations thereof.

In another alternative embodiment, an anti-wear agent can be incorporated into the coating to improve wear resistance of the magnet wire. The anti-wear agent may be ceramic particles with a hardness of at least 1000 Knopp, such ceramic particles can be carbides, nitrides, oxides, borides, and combinations thereof.

In another alternative embodiment, a coloring agent can be incorporated into the coating to evaluate the quality of the insulator and/or to identify the magnet wire during the winding operations. The coloring agent may be a metal oxide such as titanium dioxide, chromium dioxide, and combinations thereof.

In an alternative embodiment, a first layer can be applied between the electrical conductor and the coating to improve adhesion of the latter. The first layer may consist of any variety of polymer resins such as polyvinyl acetal, polyvinylformal, epoxies, and combinations thereof.

In another alternative embodiment, the magnet wire may include a layer of adhesive applied around the coating in order to adhere the turns of the wire into a winding. The adhesive layer may be formed of any variety of thermo-setting adhesive resins, such as polyamide, polyester, epoxic adhesive, polyvinyl butyral, and their combinations.

In an alternative embodiment, the coating may incorporate a flexibility promoting agent in order to improve flexibility. The flexibility promoting agent can be a polymeric resin such as polyglycol urea or similar.

### Preparation Mode

It is important that the composition of the coating of the invention can be manufactured by high shear mixing, fusion, high energy dispersion, ultrasonic dispersion, by the use of known chemical dispersants, the use of one or various solvents in said mixture or in a sequential manner, by using known concentrated dispersions as master mixtures, combinations of these techniques for mixing, and any other mixing method that effectively disperse the fullerene-type nanostructures in the polymer resin.

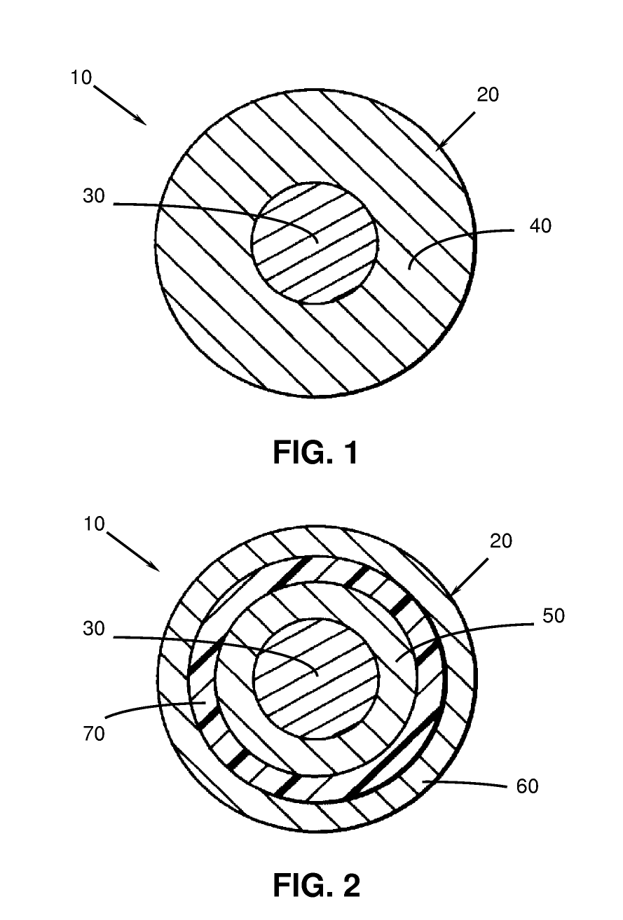

Referring now to FIGS. 1, 2 and 3, there is a magnet wire 10 comprising a coating 20 arranged around an electrical conductor 30. The electrical conductor 30 is, typically, a wire or a laminated conductor of any conductive material, as required. For example, the electrical conductor 30 can be made of copper, aluminum covered with copper, silver plated copper, nickel plated copper, gold plated copper, an aluminum alloy 1350, combinations of these or similar. The electrical conductor 30 is manufactured to meet or exceed all requirements of ANSI/NEMA MW1000.

The coating 20 has electrical insulating, flexibility and corona-resistant properties and/or a low coefficient of friction, thus it serves as electrical insulation for the electrical wire 30. The coating 20 is protected against dielectric degradation caused by overvoltage of pulses associated with the variable frequency, PWM and/or inverted pulses of AC motors, and moreover, it can also have a low coefficient of friction. Therefore, the magnet wire 10 of the invention comprises a base coating that can be used in any application for a magnet wire which were presented in the background of the invention. Moreover, the coating 20 of the invention, comprising fullerene-type nanostructures, shows an extended lifetime compared to conventional wire when subjected to dielectric stresses experienced in the environment of high frequency and electric voltage, such as in inverter drives controlled by a motor.

In the first embodiment shown in FIG. 1, coating 20 includes a single layer 40 consisting of a mixture of polymeric resin as a base coating and fullerene-type nanostructures such as semi-conductor material in a weight range of 82% to 99.95% by weight of polymer resin, and 0.05% to 18% by weight of fullerene-type nanostructures.

The polymer resin has a dielectric resistance of at least about 7874 V/mm (200 V/mil), while layer 40 has a conductivity in a range of about 1×10⁻¹² S/cm to about 1×10³ S/cm and/or a coefficient of friction of 0.09 to 0.016.

The addition of at least a sufficient amount of fullerene-type nanostructures in a base coating of polymer resin to form a coating 20, improving greatly to the resistance of corona and decreases considerably the coefficient of friction of the magnet wire 10.

The coating 20 is applied uniformly, continuously and concentrically on the electrical conductor 30 by any conventional means, such as a conventional solvent application, application by extrusion or electrostatic deposit. More preferably, said coating 20 of a unique layer is formed by one or more thermoplastic or polymer resins or liquid thermosets completed with fullerene-type nanostructures that are homogeneously disperse. The coating 20 is applied on the electrical conductor 30 and then dried and/or cured, as needed, using one or more adequate techniques of curing and/or drying, such as chemical, radiation, or thermal treatments.

Looking now at FIG. 2, a second embodiment of magnet wire 10 of the invention is shown. The coating 20 is composed of alternating layers of polymer resin and polymer resin layers completed with homogeneously disperse fullerene-type nanostructures. In this embodiment, the electrical conductor 30 is covered with coating 20 composed by an inner layer 50 and an external layer 60 of polymeric resin, with an intermediate layer 70 of polymeric resin completed with homogeneously disperse fullerene-type nanostructures.

Although the coating 20 is shown as comprising these three layers, more or less layers could be used, depending on whether one or more aspects of the invention will be incorporated into the magnet wire 10.

The inner layer 50 is applied peripherally around the electrical conductor 30 and serves as a flexible base coating and electrical insulation for a coating 20. Because its electrical insulation properties, the first inner layer 50 helps to isolate the electrical conductor 30 when the electrical conductor leads 30 electrical current during the operations of the electrical device. Due to its characteristics of flexibility, the first inner layer 50 helps prevent the intermediate layer 70 from cracking and/or delamination when the magnet wire 10 is wound around the windings of an electrical device, such as a motor, generator, transformer, reactor and an electric actuator. The middle layer 70 includes sufficient quantities of fullerene-type nanostructures. The first flexible inner layer 50, together with the third flexible outer layer 60, actually confine and strengthen the middle layer 70, and thus substantially reduce or even eliminate the tendency of the middle layer 70 to cracking or delaminating during the winding operations. The third outer layer 60 also contributes to the thermal insulation properties, as well as to impact resistance, scraping resistance, and the ability to enroll.

The inner layer 50 and the outer layer 60 can be formed by any variety of such polymer resins as described above. Whereas the middle layer 70 can be formed by a combination of at least one polymeric resin with fullerene-type nanostructures in a range in weight of 82% to 99.95% by weight of polymeric resin, and of 0.05% to 18% by weight of fullerene-type nanostructures. The polymer resin has a dielectric resistance of at least about 7874 V/mm (200 V/mil), while layer 70 has a conductivity in a range of about 1×10-12 S/cm to about 1×103 S/cm and/or a coefficient of friction of 0.09 to 0.016.

The inclusion of an intermediate layer 70 of a combination of at least one polymeric resin with fullerene-type nanostructures between at least two layers of polymeric resin to form a coating 20 improves in great part the corona-resistance of the magnet wire 10.

The coating 20 may be formed on the electrical conductor 30 using conventional coating processes that are well known in state of art. In general, homogeneous mixtures are prepared comprising the compounds of each layer 50, 60, and 70 dispersed in a suitable solvent (described above), and then applied on the electrical conductor 30 with the use of multiple stages of coating and sliding dies. The formation of the insulation is typically dried and cured in an oven after each stage.

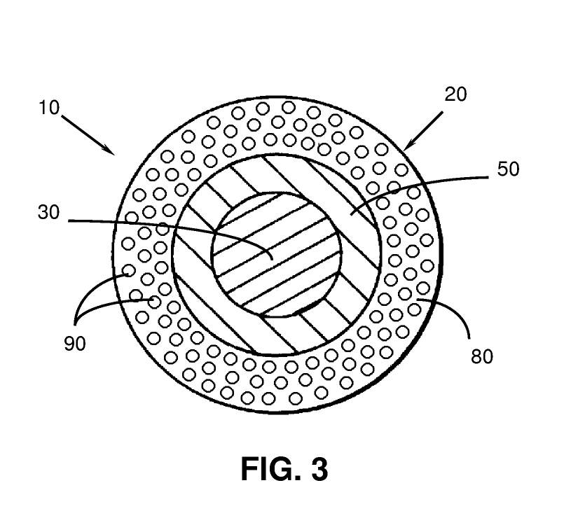

FIG. 3 shows a third embodiment of magnet wire 10 of the invention. Coating 20 is composed of alternating layers of polymer resin and polymer resin layers completed with homogeneously disperse fullerene-type nanostructures. In this embodiment, the electrical conductor 30 is covered with coating 20 composed by an inner layer 50 of polymeric resin, with an external layer 80 of polymeric resin with particles of fullerene-type nanostructures as a load.

Although the coating 20 is shown as comprising these two layers, there could be used more or fewer layers of polymer resin with particles of fullerene-type nanostructures, depending on whether one or more aspects of the invention (corona resistance and/or under a coefficient of friction) should be incorporated into the magnet wire 10.

The inner layer 50 is applied peripherally around the electrical conductor 30 and serves as a flexible base coating and electrical insulation for a coating 20. Because of its electrical insulation properties, the first inner layer 50 helps to isolate the electrical conductor 30 when the electrical conductor 30 leads electrical current during the operations of an electrical device. Due to its characteristics of flexibility, the first inner layer 50 helps preventing the outer layer 80 from cracking and/or delamination when the magnet wire 10 is wound around the windings of an electrical device. The outer layer 80 includes particles of fullerene-type nanostructures in at least one polymeric resin.

The outer layer 80 includes homogeneously dispersed particles of fullerene-type nanostructures in at least a polymeric resin that acts as a binder. The outer layer 80 includes a sufficient amount of fullerene-type nanostructures particles to provide a magnet wire 10 with characteristics of resistance to corona and/or a low coefficient of friction. In the practice of the invention, an electrical conductor covered such as the magnet wire 10 must have a resistance to corona if, when submitted to one or more pulses of electrical voltage greater than the initial voltage of corona, the time to failure by a short circuit is at least 50 times more, preferably at least 10 times, and even more preferably at least up to 100 times than the one of an electrical conductor without this coating, which is otherwise identical to the electrical conductor covered with this coating.

Selecting an appropriate content of particles of the fullerene-type nanostructures to be used in the outer layer 80, it is necessary to keep the balance between the competitive performance and practical matters. For example, if the content of fullerene-type nanostructures particles in the outer layer 80 is too low, the outer layer 80 may have an insufficient resistance to corona. On the other hand, if the content of fullerene-type nanostructures particles in the outer layer 80 is too high, the outer layer 80 may be too brittle so that this outer layer 80 could crack or delaminate during the winding operations. Using more particles of fullerene-type nanostructures that are needed to provide the desired degree of resistance to corona, may also unnecessarily increase the cost of production of the magnet wire 10 and at the same time make it harder to manufacture the outer layer 80. In general, within the practice of the invention, 85% to 99.95% by weight of polymer resin are included, and 0.05% to 15% by weight of fullerene-type nanostructures.

The incorporation of particles of fullerene-type nanostructures such as a load on an outer layer 80 in the corona-resistant coating 20 will vastly improve the resistance to corona of the magnet wire 10 and may reduce its coefficient of friction depending on the type of fullerene-type nanostructures used. In this embodiment, the inner layer 50 serves as a flexible base coating and electrical insulator, and the outer layer 80 includes disperse particles of fullerene-type nanostructures 90 in at least one polymeric resin that acts as a binder to provide the properties of corona-resistance and/or of a low coefficient of friction. The outer layer 80 also provides electrical insulation properties. The fullerene-type nanostructures particles 90 provide semi-conductive properties to the outer layer 80. Therefore, the outer layer 80 as a semi-conductor is able to disperse the concentration of local electric charge and thus form a protective layer around the inner layer 50. Because of this protective layer, the inner layer 50 is prevented from being attacked by erosion due to corona. As a result, the insulating properties of the inner layer 50 and outer layer 80 are retained.

In the practice of the invention, it is generally desirable to use such fullerene-type nanostructure particles that have a mean particle size of the smallest that can be found, because the smallest particles have a bigger surface which reduces the electrical distances within the material, and therefore dissipate more energy within the insulation and at the same time form an improved barrier compared with the use of larger particles. In general, the fullerene-type nanostructure particles having at least one dimension less than 100 nm would be suitable for the practice of the invention.

The corona-resistant coating 20 and/or of low coefficient of friction can be formed on the electrical conductor 30 using conventional coating processes that are well known in state of art. In general, homogeneous mixtures are prepared comprising the compounds of each layer 50 and 80 dispersed in a suitable solvent (described above), and then applied on the electrical conductor 30 with the use of multiple stages of coating and sliding dies. The formation of the insulation is typically dried and cured in an oven after each stage.

### EXAMPLES OF THE INVENTION

The invention will now be described with respect to the following examples, which are solely for the purpose of representing the way of carrying out the implementation of the principles of the invention. The following examples are not intended to be a comprehensive representation of the invention, or try to limit the scope thereof.

### Magnet Wire of Control A

An electrical copper conductor, round, conventional 18-gauge, meeting or exceeding all requirements of ANSI/NEMA MW1000 MW35 and/or the standard 73 MW for heavy construction, is manufactured to serve as a reference control in the invention. The wire is covered concentrically and continually using a conventional machine for coating magnet wire with a base coating (inner layer) of a modified polyester insulation, commercially available as THEIC of Elantas PDG under the trade name “TERESTER 966”. Thus, the increase in diameter due to the base coating (inner layer) is approximately 0.0635 mm (0.0025 in). An outer layer of polyamidaimide enamel is applied to the base coating increasing the diameter by 0.0102 mm (0.0004 in).

### Magnet Wire of Control B

An electrical copper conductor, round, conventional 18-gauge, meeting or exceeding all requirements of ANSI/NEMA MW1000 MW35 and/or the standard 73 MW for heavy construction, is manufactured to serve as a reference control in the invention. The wire is covered concentrically and continually using a conventional machine for coating magnet wire with a base coating (inner layer) of a modified polyester insulation, commercially available as THEIC of Elantas PDG under the trade name “TERESTER 966”. Thus, the increase in diameter due to the base coating (inner layer) is approximately 0.0680 mm (0.0027 in). An outer layer of polyamidaimide enamel is applied to the base coating increasing the diameter by 0.01520 mm (0.0006 in).

### Example I

### An Embodiment of the Invention

An electrical copper conductor, round, gauge 18, meeting or exceeding all requirements of standard ANSI/NEMA MW1000 MW35 and/or standard MW 73 of heavy construction, is covered concentrically using a conventional machine to coat an magnet wire with a base coating (inner layer) with a insulation of modified polyesterimide. In this way, the increase in diameter due to the base coating (inner layer) is approximately 0.0673 mm (0.0027 in).

3.03 kg (6.68 lb) of a dispersion of multi-walled nanotubes are added slowly to 19 kg (41.88 lb) of a conventional polyamidaimide enamel in a shaker-type mixer, and in order to maintain a homogenous dispersion, the mixture is kept under agitation for 2 hours at a temperature of 30° C. to 40° C. The dispersion of multi-walled nanotubes is composed of 2% by weight of multi-walled nanotubes with an average inner diameter of 4 nm, an average outer diameter of 13 nm to 16 nm, and a length to diameter ratio close to 1,000, 98% n-methyl pyrrolidone, and 6.1 g of polyvinylpyrrolidone as a dispersant, whereas conventional poliamidaimida enamel is composed of 30% by weight of a polyamidaimide resin that includes a promoting agent of sliding in a solvent system composed of n-methylpyrrolidone and aromatic hydrocarbon. The resulting semi-conductor enamel is applied concentrically and continual to the coating base (inner layer), forming a protective barrier or shield layer (outer layer) around the inner layer, thus the increase in diameter due to the shield layer (outer layer) is approximately 0.0170 mm (0.0007 in).

### Example I

### An Embodiment of the Invention

An electrical copper conductor, round, gauge 18, meeting or exceeding all requirements of standard ANSI/NEMA MW1000 MW35 and/or standard MW 73 of heavy construction, is covered concentrically using a conventional machine to coat an magnet wire with a base coating (inner layer) with a insulation of modified polyesterimide. In this way, the increase in diameter due to the base coating (inner layer) is approximately 0.0780 mm (0.0031 in).

3.23 kg (7.12 lb) of a dispersion of multi-walled nanotubes are added slowly to 19 kg (41.88 lb) of a conventional polyamidaimide enamel in a shaker-type mixer, and in order to maintain a homogenous dispersion, the mixture is kept under agitation for 2 hours at a temperature of 30° C. to 40° C. The dispersion of multi-walled nanotubes is composed of 2% by weight of multi-walled nanotubes with an average inner diameter of 4 nm, an average outer diameter of 13 nm to 16 nm, and a length to diameter ratio close to 1,000, 98% n-methyl pyrrolidone, and 6.5 g of polyvinylpyrrolidone as a dispersant, whereas conventional polyamidaimide enamel is composed of 30% by weight of a polyamidaimide resin that includes a promoting agent of sliding in a solvent system composed of n-methylpyrrolidone and aromatic hydrocarbon. The resulting semi-conductor enamel is applied concentrically and continually to the coating base (inner layer), forming a protective barrier or shield layer (outer layer) around the inner layer, thus the increase in diameter due to the shield layer (outer layer) is approximately 0.0030 mm (0.0001 in).

### Example III

### An Embodiment of the Invention

An electrical copper conductor, round, gauge 18, meeting or exceeding all requirements of standard ANSI/NEMA MW1000 MW35 and/or standard MW 73 of heavy construction, is covered concentrically and continually using a conventional machine to coat an magnet wire with a base coating (inner layer) and a shield layer (outer layer) of the same composition and preparation mode as the base layer and shield layer from Example II respectively, except that the increase in the diameter due to the base coating (inner layer) is approximately 0.069 mm (0.00273 in), that for the shield layer (outer layer) 3.23 kg (7.12 lb) is used of the dispersion of multi-walled nanotubes and that the increase in diameter due to the shield layer (outer layer) is approximately 0.018 mm (0.0007 in).

### Example IV

### An Embodiment of the Invention

An electrical copper conductor, round, gauge 18, meeting or exceeding all requirements of standard ANSI/NEMA MW1000 MW35 and/or standard MW 73 of heavy construction, is covered concentrically using a conventional machine to coat magnet wire with a base coating (inner layer) of a modified polyesterimide insulation. In this way, the increase in diameter due to the base coating (inner layer) is approximately 0.0680 mm (0.0027 in).

3.71 kg (8.18 lb) of a dispersion of multi-walled nanotubes are added slowly to 19 kg (41.88 lb) of a conventional polyamidaimide enamel in a shaker-type mixer, and in order to maintain a homogenous dispersion, the mixture is kept under agitation for 2 hours at a temperature of 30° C. to 40° C. The dispersion of multi-walled nanotubes is composed of 2% by weight of multi-walled nanotubes with an average inner diameter of 4 nm, an average outer diameter of 13 nm to 16 nm, and a length to diameter ratio close to 1,000, 98% n-methyl pyrrolidone, and 7.5 g of polyvinylpyrrolidone as a dispersant, whereas conventional polyamidaimide enamel is composed of 30% by weight of a polyamidaimide resin that includes a promoting agent of sliding in a solvent system composed of n-methylpyrrolidone and aromatic hydrocarbon. The resulting semi-conductor enamel is applied concentrically and continual to the coating base (inner layer), forming a protective barrier or shield layer (outer layer) around the inner layer, thus the increase in diameter due to the shield layer (outer layer) is approximately 0.0140 mm (0.0006 in).

### Example V

### An Embodiment of the Invention

An electrical copper conductor, round, gauge 18, meeting or exceeding all requirements of standard ANSI/NEMA MW1000 MW35 and/or standard MW 73 of heavy construction, is covered heavily, concentrically and continually, with a base coating (inner layer) and a shield layer (outer layer) of the same composition and preparation mode as the base coating and shield layer from Example IV respectively, except that the increase in the diameter due to the base coating (inner layer) is approximately 0.0700 mm (0.0027 in), and that the increase in diameter due to the shield layer (outer layer) is approximately 0.0180 mm (0.0007 in).

### Example VI

### An Embodiment of the Invention

An electrical copper conductor, round, gauge 18, meeting or exceeding all requirements of standard ANSI/NEMA MW1000 MW35 and/or standard MW 73 of heavy construction, is covered heavily, concentrically and continually, with a base coating (inner layer) and a shield layer (outer layer) of the same composition and preparation mode as the base coating and shield layer from Example IV respectively, except that the increase in the diameter due to the base coating (inner layer) is approximately 0.0580 mm (0.0023 in), and that the increase in diameter due to the shield layer (outer layer) is approximately 0.0260 mm (0.0010 in).

### Example VII

### An Embodiment of the Invention

An electrical copper conductor, round, gauge 18, meeting or exceeding all requirements of standard ANSI/NEMA MW1000 MW35 and/or standard MW 73 of heavy construction, is covered concentrically using a conventional machine to coat magnet wire with a base coating (inner layer) of a modified polyesterimide insulation. In this way, the increase in diameter due to the base coating (inner layer) is approximately 0.0800 mm (0.0032 in).

4.19 kg (9.17 lb) of a dispersion of multi-walled nanotubes are added slowly to 19 kg (41.88 lb) of a conventional polyamidaimide enamel in a shaker-type mixer, and in order to maintain a homogenous dispersion, the mixture is kept under agitation for 2 hours at a temperature of 30° C. to 40° C. The dispersion of multi-walled nanotubes is composed of 2% by weight of multi-walled nanotubes with an average inner diameter of 4 nm, an average outer diameter of 13 nm to 16 nm, and a length to diameter ratio close to 1,000, 98% n-methyl pyrrolidone, and 8.4 g of polyvinylpyrrolidone as a dispersant, whereas conventional polyamidaimide enamel is composed of 30% by weight of a polyamidaimide resin that includes a promoting agent of sliding in a solvent system composed of n-methylpyrrolidone and aromatic hydrocarbon. The resulting semi-conductor enamel is applied concentrically and continual to the coating base (inner layer), forming a protective barrier or shield layer (outer layer) around the inner layer, thus the increase in diameter due to the shield layer (outer layer) is approximately 0.0050 mm (0.0002 in).

### Example VIII

### An Embodiment of the Invention

An electrical copper conductor, round, gauge 18, meeting or exceeding all requirements of standard ANSI/NEMA MW1000 MW35 and/or standard MW 73 of heavy construction, is covered heavily, concentrically and continually, with a base coating (inner layer) and a shield layer (outer layer) of the same composition and preparation mode as the base coating and shield layer from Example VII respectively, except that the increase in the diameter due to the base coating (inner layer) is approximately 0.0600 mm (0.0024 in), and that the increase in diameter due to the shield layer (outer layer) is approximately 0.0026 mm (0.0010 in).

### Example IX

### An Embodiment of the Invention

An electrical copper conductor, round, gauge 18, meeting or exceeding all requirements of standard ANSI/NEMA MW1000 MW35 and/or standard MW 73 of heavy construction, is covered concentrically using a conventional machine to coat magnet wire with a base coating (inner layer) of a modified polyesterimide insulation. In this way, the increase in diameter due to the base coating (inner layer) is approximately 0.0670 mm (0.0026 in).

4.39 kg (9.67 lb) of a dispersion of multi-walled nanotubes are added slowly to 19 kg (41.88 lb) of a conventional polyamidaimide enamel in a shaker-type mixer, and in order to maintain a homogenous dispersion, the mixture is kept under agitation for 2 hours at a temperature of 30° C. to 40° C. The dispersion of multi-walled nanotubes is composed of 2% by weight of multi-walled nanotubes with an average inner diameter of 4 nm, an average outer diameter of 13 nm to 16 nm, and a length to diameter ratio close to 1,000, 98% n-methyl pyrrolidone, and 8.8 g of polyvinylpyrrolidone as a dispersant, whereas conventional polyamidaimide enamel is composed of 30% by weight of a polyamidaimide resin that includes a promoting agent of sliding in a solvent system composed of n-methylpyrrolidone and aromatic hydrocarbon. The resulting semi-conductor enamel is applied concentrically and continual to the coating base (inner layer), forming a protective barrier or shield layer (outer layer) around the inner layer, thus the increase in diameter due to the shield layer (outer layer) is approximately 0.0180 mm (0.0007 in).

### Example X

### An Embodiment of the Invention

An electrical copper conductor, round, gauge 18, meeting or exceeding all requirements of standard ANSI/NEMA MW1000 MW35 and/or standard MW 73 of heavy construction, is covered heavily, concentrically and continually, with a base coating (inner layer) and a shield layer (outer layer) of the same composition and preparation mode as the base coating and shield layer from Example IX respectively, except that the increase in the diameter due to the base coating (inner layer) is approximately 0.0620 mm (0.0024 in), and that the increase in diameter due to the shield layer (outer layer) is approximately 0.0230 mm (0.0009 in).

### Example XI

### An Embodiment of the Invention

An electrical copper conductor, round, gauge 18, meeting or exceeding all requirements of standard ANSI/NEMA MW1000 MW35 and/or standard MW 73 of heavy construction, is covered concentrically using a conventional machine to coat magnet wire with a base coating (inner layer) of a modified polyesterimide insulation. In this way, the increase in diameter due to the base coating (inner layer) is approximately 0.0654 mm (0.0026 in).

0.1702 kg (0.375 lb) of tungsten disulfide fullerene with a specific surface area of approximately 25 m² to 30 m² are added to 20 kg (44.09 lb) of a conventional polyamidaimide enamel is composed of 30% by weight of a polyamidaimide resin which includes slide-promoting agent in a solvent system composed of n-methylpyrrolidone and an aromatic hydrocarbon. The tungsten disulfide fullerene is dispersed in conventional polyamidaimide enamel through high shear mixing using a ball mill. The resulting semi-conductor enamel is applied concentrically and continual to the coating base (inner layer), forming a protective barrier or shield layer (outer layer) around the inner layer, thus the increase in diameter due to the shield layer (outer layer) is approximately 0.0159 mm (0.0006 in).

### Example XII

### An Embodiment of the Invention

An electrical copper conductor, round, gauge 18, meeting or exceeding all requirements of standard ANSI/NEMA MW1000 MW35 and/or standard MW 73 of heavy construction, is covered concentrically and continually, with a base coating (inner layer) and a shield layer (outer layer) of the same composition and preparation mode as the base coating and shield layer from Example XI respectively, except that the increase in the diameter due to the base coating (inner layer) is approximately 0.0545 mm (0.0021 in), and that the increase in diameter due to the shield layer (outer layer) is approximately 0.0267 mm (0.0011 in).

### Example XIII

### An Embodiment of the Invention

An electrical copper conductor, round, conventional 18-gauge, meeting or exceeding all requirements of ANSI/NEMA MW1000 MW35 and/or the standard 73 MW for heavy construction, is manufactured to serve as a reference control in the invention. The wire is covered concentrically and continually using a conventional machine for coating the magnet wire with a base coating (inner layer) of a modified polyester insulation, commercially available as THEIC. In this way, the increase in diameter due to the base coating (inner layer) is approximately 0.0763 mm (0.0003 in).

0.4516 kg (0.995 lb) of tungsten disulfide fullerene with a specific surface area of approximately 25 m² to 30 m² are added to 20 kg (44.09 lb) of a conventional polyamidaimide enamel is composed of 30% by weight of a polyamidaimide resin which includes slide-promoting agent in a solvent system composed of n-methylpyrrolidone and an aromatic hydrocarbon. The tungsten disulfide fullerene is dispersed in conventional polyamidaimide enamel through high shear mixing using a ball mill. The resulting semi-conductor enamel is applied concentrically and continual to the coating base (inner layer), forming a protective barrier or shield layer (outer layer) around the inner layer, thus the increase in diameter due to the shield layer (outer layer) is approximately 0.0049 mm (0.0002 in).

### Example XIV

### An Embodiment of the Invention

An electrical copper conductor, round, gauge 18, meeting or exceeding all requirements of standard ANSI/NEMA MW1000 MW35 and/or standard MW 73 of heavy construction, is covered concentrically and continually with a base coating (inner layer) and a shield layer from Example XIII respectively, except that the increase in the diameter due to the base coating (inner layer) is approximately 0.0654 mm (0.0026 in), that for the shield layer (outer layer) 0.25 kg (0.55 lb) is used of tungsten disulfide fullerene and that the increase in diameter due to the shield layer (outer layer) is approximately 0.0159 mm (0.0006 in).

### Example XV

### An Embodiment of the Invention

An electrical copper conductor, round, gauge 18, meeting or exceeding all requirements of standard ANSI/NEMA MW1000 MW35 and/or standard MW 73 of heavy construction, is covered concentrically and continually with a base coating (inner layer) and a shield layer from Example XIII respectively, except that the increase in the diameter due to the base coating (inner layer) is approximately 0.0732 mm (0.0029 in), that for the shield layer (outer layer) 0.667 kg (1.47 lb) is used of tungsten disulfide fullerene and that the increase in diameter due to the shield layer (outer layer) is approximately 0.0081 mm (0.0003 in).

### Example XVI

### An Embodiment of the Invention

An electrical copper conductor, round, gauge 18, meeting or exceeding all requirements of standard ANSI/NEMA MW1000 MW35 and/or standard MW 73 of heavy construction, is covered concentrically and continually, with a base coating (inner layer) and a shield layer (outer layer) of the same composition and preparation mode as the base coating and shield layer from Example XV respectively, except that the increase in the diameter due to the base coating (inner layer) is approximately 0.0577 mm (0.0023 in), and that the increase in diameter due to the shield layer (outer layer) is approximately 0.0236 mm (0.0009 in).

### Example XVII

### An Embodiment of the Invention

An electrical copper conductor, round, gauge 18, meeting or exceeding all requirements of standard ANSI/NEMA MW1000 MW35 and/or standard MW 73 of heavy construction, is covered concentrically and continually with a base coating (inner layer) and a shield layer from Example XIII respectively, except that the increase in the diameter due to the base coating (inner layer) is approximately 0.0545 mm (0.0021 in), that for the shield layer (outer layer) 0.760 kg (1.67 lb) is used of tungsten disulfide fullerene and that the increase in diameter due to the shield layer (outer layer) is approximately 0.0267 mm (0.0015 in).

### Tests Performed

The magnet wires of control A and of the Examples I to X were electrically stressed to measure their resistance to the corona effect by applying a voltage with an approximate square waveform, a duty cycle of 50%, a magnitude of +/−1,000V, a formation time of 2 microseconds and a frequency of 20 kHz. The magnet wire is submitted to thermal stresses in a forced convection oven at a temperature of 160° C. (320° F.) with a preheating period of 14 hours at 140° C. (284° F.). A total of sixteen standard twisted wire pairs for each sample are tested under the above conditions until a power failure occurs. The mean time to failure (MTTF) calculated, assuming a Weibull distribution and 95% intervals of confidence for the same are shown in Table 1.

TABLE 1

| | Confidence interval 95% | | | |
|---|---|---|---|---|
| | MTTF mean time | Lower | Upper | |
| | to failure | Limit | Limit | Correlation |
| Magnet wire | (seconds) | (seconds) | (seconds) | coefficient |
| Control A | 1965 | 1703 | 2269 | 0.897 |
| Example I | 4783 | 4091 | 5591 | 0.981 |
| Example II | 8585 | 7043 | 10464 | 0.984 |
| Example III | 3298 | 3087 | 3523 | 0.931 |
| Example IV | 5168 | 4772 | 5596 | 0.909 |
| Example V | 5849 | 5037 | 6791 | 0.847 |
| Example VI | 3436 | 3210 | 3677 | 0.971 |
| Example VII | 4768 | 4308 | 5277 | 0.992 |
| Example VIII | 2989 | 2879 | 3104 | 0.94 |
| Example IX | 4393 | 3762 | 5129 | 0.933 |
| Example X | 7260 | 6347 | 8305 | 0.956 |

It can be observed that the magnet wires of Examples I to X improved in this invention meet or exceed all requirements of ANSI/NEMA MW1000. The magnet wire of this invention also supports electrical and thermal stresses similar to those that occur when electrical devices are used with an AC variable frequency PWM (power management) and/or inverter drives. Therefore, the magnet wire with the coating of this invention can be used by manufacturers of electrical devices to produce windings for electrical devices that operate under conditions of corona discharge.

On the other hand, the magnet wires of Control B and from the Examples XI to XVII are evaluated under the standard NEMA MW 750-1998 to measure the dynamic coefficient of friction as shown in Table 2.

TABLE 2

| | Confidence interval 95% | | |
|---|---|---|---|
| | Dynamic | Dynamic | Dynamic |
| | coefficient of | coefficient of | coefficient of |
| Magnet wire | friction Reading 1 | friction Reading 2 | friction average |
| Control B | 0.124 | 0.144 | 0.134 |
| Example XI | 0.195 | 0.194 | 0.1945 |
| Example XII | 0.183 | 0.285 | 0.234 |
| Example XIII | 0.110 | 0.101 | 0.105 |
| Example XIV | 0.133 | 0.104 | 0.118 |
| Example XV | 0.109 | 0.083 | 0.096 |
| Example XVI | 0.111 | 0.104 | 0.107 |
| Example XVII | 0.101 | 0.094 | 0.097 |

It can be observed that the magnet wires of Examples XI to XVII according to the invention have a low coefficient of friction. Incorporating the fullerene-type nanostructures in a magnet wire coating according to the invention allows obtaining a magnet wire with a dry and slippery surface that enables high-speed winding, and that the slipperiness of the surface does not prevent subsequent coating nor the adhesion of other coatings.

Although the invention was described with reference to specific embodiments, this description is not intended to be built in a limited sense. The different modifications of the embodiments published, as well as alternative embodiments of the invention will be apparent to persons knowledgeable in the state of the art when referring to the description of the invention. For this reason it is considered that the appended claims cover such modifications that fall within the scope of the invention, or their equivalents.

1. A magnet wire consisting of an electrical conductor and a coating around the electrical conductor, wherein the coating is resistant to corona and/or of a low coefficient of friction and including:
from 82% to 99.95% by weight of polymer resin; and
from 0.05% to 18% by weight of fullerene-type nanostructures.

2. The magnet wire of claim 1, wherein the corona-resistant coating is formed by alternating layers of polymer resin and layers consisting of a mixture of polymer resin and fullerene-type nanostructures.

3. The magnet wire of claim 1, wherein the corona-resistant coating is formed by an inner layer and an outer layer of polymer resin and an intermediate layer of a mixture of polymer resin and fullerene-type nanostructures.

4. The magnet wire of claim 1, wherein the corona-resistant coating is formed by a single layer of a mixture of polymer resin and fullerene-type nanostructures.

5. The magnet wire of claim 1, wherein the polymer resin is thermoplastic or thermoset selected from a group consisting of acrylic, alkyd of terephthalic acid, polyester, polyesterimide, polyesteramide, polyesteramidaimide, polyesterurethane, polyurethane, epoxy resin, polyvinylformal, polyamide, polyimide, polyamidaimide, polysulfone, polyvinylbutiral, silicon resin, polymer incorporating polyhydantoin, phenol resin, vinyl copolymer, polyolefin, polycarbonate, polyether, polyetherimide, polyetheramide, polyetheramideimide, polyisocyanate, polyesteramideimide, polyamide-ester, polyimida-ester, and combinations thereof.

6. The magnet wire of claim 1, wherein the polymeric resin has a dielectric resistance of at least about 7874 V/mm (200 V/mil).

7. The magnet wire of claim 1, wherein the fullerene-type nanostructures are selected from a group consisting of C₆₀, C₇₀, C₇₆, C₇₈, C₈₄, C₉₆, C₁₀₈, C₁₂₀, single-walled carbon nanotubes, double-walled carbon nanotubes, multi-walled carbon nanotubes, boron-carbon nanotubes, tungsten-carbon nanotubes, tungsten disulfide nanotubes, titanium dioxide nanotubes, carbon fullerene with a surface treatment, metal fullerene, tungsten disulfide fullerene, molybdenum disulfide fullerene, nanotubes with a surface treatment, and combinations thereof.

8. The magnet wire of claim 1, wherein the fullerene-type nanostructures have at least one dimension smaller than 100 nm.

9. The magnet wire of claim 1, wherein further the polymeric resin and the fullerene-type nanostructures are dissolved in one or more solvents selected from a group consisting of cresylic acid, N-methyl pyrrolidone, phenol, aromatic hydrocarbons, dimethylformamide, mesitol, benzyl alcohol, paracresol, metacresol, m-cresol, toluene, xylene, tetrahydrofuran, dimethyl sulfoxide, butyl alcohol, butyl cellosolve, and combinations thereof.

10. The magnet wire of claim 1, wherein further comprising a first layer between the electrical conductor and the coating.

11. The magnet wire of claim 10, wherein the first layer comprising a polymeric resin selected from a group consisting of polyvinyl acetal, polyvinylformal, epoxic resins, and combinations thereof.

12. The magnet wire of claim 1, wherein further comprising an adhesive layer arranged around the coating, wherein the adhesive layer comprising a thermo-setting adhesive resin selected from a group consisting of polyamide, polyester, epoxic adhesive, polyvinyl butyral, and combinations thereof.

13. The magnet wire of claim 1, wherein further the coating comprising polyglycol urea as a flexibility promoting agent.

14. The magnet wire of claim 1, wherein further the coating comprising a sliding promoting agent selected from a group consisting of polyvinyl fluoride, tetrafluoroethylene-perfluoro(alky vinyl ethylene) copolymer, tetrafluoroethylene-hexafluoropropylene-perfluoro(alkyl vinyl ether) copolymer, tetrafluoroethylene-perfluoro(alkyl vinyl ether) copolymer, ethylene-tetrafluoroethylene copolymer, polytetrafluoroethylene, polyvinylidene fluoride, ethylene-chlorotrifluoroethylene copolymer, polychloro-trifluoroethylene, carnauba, montan wax, and combinations thereof.

15. The magnet wire of claim 1, wherein further the coating comprising an anti-wear agent, wherein the anti-wear agent is at least one ceramic particle with a hardness Knopp of at least 1000, wherein said ceramic particle is selected from a group consisting of carbides, nitrides, oxides, borides, and combinations thereof.

16. The magnet wire of claim 1, wherein further the coating comprising a coloring agent selected from a group consisting of titanium dioxide, chromium dioxide, and combinations thereof.

17. The magnet wire of claim 1, wherein said coating has a conductivity of 1×10⁻¹² S/cm to 1×10³ S/cm.

18. The magnet wire of claim 1, wherein said coating has a friction coefficient of 0.09 to 0.016.

19. A coating composition resistant to corona and/or of a low coefficient of friction, including:
from 82% to 99.95% by weight of polymer resin; and
from 0.05% to 18% by weight of fullerene-type nanostructures.

20. The coating composition of claim 19, wherein the polymer resin is thermoplastic or thermoset selected from a group consisting of acrylic, alkyd of terephthalic acid, polyester, polyesterimide, polyesteramide, polyesteramidaimide, polyesterurethane, polyurethane, epoxy resin, polyvinylformal, polyamide, polyimide, polyamidaimide, polysulfone, polyvinylbutiral, silicon resin, polymer incorporating polyhydantoin, phenol resin, vinyl copolymer, polyolefin, polycarbonate, polyether, polyetherimide, polyetheramide, polyetheramideimide, polyisocyanate, polyesteramideimide, polyamide-ester, polyimida-ester, and combinations thereof.

21. The coating composition of claim 19, wherein the polymeric resin has a dielectric resistance of at least about 7874 V/mm (200 V/mil).

22. The coating composition of claim 19, wherein the fullerene-type nanostructures are selected from a group consisting of C₆₀, C₇₀, C₇₆, C₇₈, C₈₄, C₉₆, C₁₀₈, C₁₂₀, single-walled carbon nanotubes, double-walled carbon nanotubes, multi-walled carbon nanotubes, boron-carbon nanotubes, tungsten-carbon nanotubes, tungsten disulfide nanotubes, titanium dioxide nanotubes, carbon fullerene with a surface treatment, metal fullerene, tungsten disulfide fullerene, molybdenum disulfide fullerene, nanotubes with a surface treatment, and combinations thereof.

23. The coating composition of claim 19, wherein the fullerene-type nanostructures have at least one dimension smaller than 100 nm.

24. The coating composition of claim 19, wherein the polymeric resin and the fullerene-type nanostructures are dissolved in one or more solvents selected from a group consisting of cresylic acid, N-methyl pyrrolidone, phenol, aromatic hydrocarbons, dimethylformamide, mesitol, benzyl alcohol, paracresol, metacresol, m-cresol, toluene, xylene, tetrahydrofuran, dimethyl sulfoxide, butyl alcohol, butyl cellosolve, and combinations thereof.

25. The coating composition of claim 19, wherein further the coating comprising polyglycol urea as a flexibility promoting agent.

26. The coating composition of claim 19, wherein further the coating comprising a sliding promoting agent selected from a group consisting of polyvinyl fluoride, tetrafluoroethylene-perfluoro(alky vinyl ethylene) copolymer, tetrafluoroethylene-hexafluoropropylene-perfluoro(alkyl vinyl ether) copolymer, tetrafluoroethylene-perfluoro(alkyl vinyl ether) copolymer, ethylene-tetrafluoroethylene copolymer, polytetrafluoroethylene, polyvinylidene fluoride, ethylene-chlorotrifluoroethylene copolymer, polychloro-trifluoroethylene, carnauba, montan wax, and combinations thereof.

27. The coating composition of claim 19, wherein further the coating comprising an anti-wear agent, wherein the anti-wear agent is at least one ceramic particle with a Knopp hardness of at least 1000, wherein said ceramic particle is selected from a group consisting of carbides, nitrides, oxides, borides, and combinations thereof.

28. The coating composition of claim 19, wherein further the coating comprising a coloring agent selected from a group consisting of titanium dioxide, chromium dioxide, and combinations thereof.

29. The coating composition of claim 19, wherein the composition is manufactured by at least one mixing technique selected from a group consisting of high shear mixing, fusion, high energy dispersion, ultrasonic dispersion, use of chemical dispersants, use of one or more solvents in the same mixture or in a sequential manner, using master mixtures, and combinations thereof.

30. The coating composition of claim 19, wherein said coating has a conductivity of 1×10⁻¹² S/cm to 1×10³ S/cm.

31. The coating composition of claim 19, wherein said coating has a friction coefficient of 0.09 to 0.016.

32. A method for coating an electrical conductor comprising the step of coating the electrical conductor with a coating composition resistant to corona and/or of a low coefficient of friction including:
from 82% to 99.95% by weight of polymer resin; and
from 0.05% to 18% by weight of fullerene-type nanostructures.

33. The method of claim 32, wherein the step of coating the electrical conductor comprising the step of coating the electrical conductor with alternating layers of polymer resin and layers consisting of a mixture of polymeric resin and fullerene-type nanostructures.

34. The method of claim 32, wherein the step of coating the electrical conductor comprising the step of coating the electrical conductor with an inner and outer layer of polymer resin with an intermediate layer consisting of a mixture of polymeric resin and fullerene-type nanostructures.

35. The method of claim 32, wherein the step of coating the electrical conductor comprising the step of coating the electrical conductor with a sole layer of a mixture of polymer resin and fullerene-type nanostructures.

36. The method of claim 32, wherein the polymer resin is thermoplastic or thermoset selected from a group consisting of acrylic, alkyd of terephthalic acid, polyester, polyesterimide, polyesteramide, polyesteramidaimide, polyesterurethane, polyurethane, epoxy resin, polyvinylformal, polyamide, polyimide, polyamidaimide, polysulfone, polyvinylbutiral, silicon resin, polymer incorporating polyhydantoin, phenol resin, vinyl copolymer, polyolefin, polycarbonate, polyether, polyetherimide, polyetheramide, polyetheramideimide, polyisocyanate, polyesteramideimide, polyamide-ester, polyimida-ester, and combinations thereof.

37. The method of claim 32, wherein the polymeric resin has a dielectric resistance of at least about 7874 V/mm (200 V/mil).

38. The method of claim 32, wherein the fullerene-type nanostructures are selected from a group consisting of C₆₀, C₇₀, C₇₆, C₇₈, C₈₄, C₉₆, C₁₀₈, C₁₂₀, single-walled carbon nanotubes, double-walled carbon nanotubes, multi-walled carbon nanotubes, boron-carbon nanotubes, tungsten-carbon nanotubes, tungsten disulfide nanotubes, titanium dioxide nanotubes, carbon fullerene with a surface treatment, metal fullerene, tungsten disulfide fullerene, molybdenum disulfide fullerene, nanotubes with a surface treatment, and combinations thereof.

39. The method of claim 32, wherein the fullerene-type nanostructures have at least one dimension smaller than 100 nm.

40. The method of claim 32, wherein further the polymeric resin and the fullerene-type nanostructures are dissolved in one or more solvents selected from a group consisting of cresylic acid, N-methyl pyrrolidone, phenol, aromatic hydrocarbons, dimethylformamide, mesitol, benzyl alcohol, paracresol, metacresol, m-cresol, toluene, xylene, tetrahydrofuran, dimethyl sulfoxide, butyl alcohol, butyl cellosolve, and combinations thereof.

41. The method of claim 32, wherein further comprising the step of applying a first layer between the electrical conductor and the coating.

42. The method of claim 41, wherein the first layer comprising a polymeric resin selected from a group consisting of polyvinyl acetal, polyvinylformal, epoxic resins, and combinations thereof.

43. The method of claim 32, wherein further comprising the step of applying an adhesive layer around the coating.

44. The method of claim 43, wherein adhesive layer comprising a thermo-adherent resin selected from a group consisting of polyamide, polyester, epoxic adhesive, polyvinyl butyral, and combinations thereof.

45. The method of claim 32, wherein further the coating composition comprising polyglycol urea as a flexibility promoting agent.

46. The method of claim 32, wherein further the coating comprising a sliding promoting agent selected from a group consisting of polyvinyl fluoride, tetrafluoroethylene-perfluoro(alky vinyl ethylene) copolymer, tetrafluoroethylene-hexafluoropropylene-perfluoro(alkyl vinyl ether) copolymer, tetrafluoroethylene-perfluoro(alkyl vinyl ether) copolymer, ethylene-tetrafluoroethylene copolymer, polytetrafluoroethylene, polyvinylidene fluoride, ethylene-chlorotrifluoroethylene copolymer, polychlorotrifluoroethylene, carnauba, montan wax, and combinations thereof.

47. The method of claim 32, wherein further the coating composition comprising an anti-wear agent, wherein the anti-wear agent is at least one ceramic particle with a Knopp hardness of at least 1000, wherein said ceramic particle is selected from a group consisting of carbides, nitrides, oxides, borides, and combinations thereof.

48. The method of claim 32, wherein further the coating composition comprising a coloring agent selected from a group consisting of titanium dioxide, chromium dioxide, and combinations thereof.

49. The method of claim 32, wherein said coating has a conductivity of 1×10⁻¹² S/cm to 1×10³ S/cm.

50. The method of claim 32, wherein said coating has a friction coefficient of 0.09 to 0.016.

51. An electrical winding comprising a coiled magnet wire, wherein the magnet wire including a corona-resistant coating and/or of a low coefficient of friction comprising:
from 82% to 99.95% by weight of polymer resin; and
from 0.05% to 18% by weight of fullerene-type nanostructures.

52. The electrical winding of claim 51, wherein the electrical winding is used in an electrical device selected from a group consisting of an electric motor, an electric generator, an electric transformer, an electric reactor, an electric actuator, and combinations thereof.
